(19) United States
(12) Patent Application Publication
(10) Pub. No.: US 2008/0004886 A1
(43) Pub. Date: Jan. 3, 2008

(54) Software rental system and method

(75) Inventors: Phil Hames, Riseley (GB); John Thornewill, Wing (GB)

Correspondence Address: NIXON PEABODY, LLP, 401 9TH STREET, NW, SUITE 900, WASHINGTON, DC, 20004-2128, US

(73) Assignee: The Business Software Centre Limited, Maidenhead (GB)

(21) Appl. No.: 11/476,217

(22) Filed: Jun. 28, 2006

(51) Int. Cl. G06Q 10/00; G06Q 30/00

(52) U.S. Cl. 705/1

(57) ABSTRACT

A software rental system is described for controlling the use of rented software on a user's computer. On the user's computer a control module uses stored access control parameters obtained from a server over a network to control software programs. The access control parameters are obtained and periodically updated from the server.

### FIELD OF THE INVENTION

The present invention generally relates to a system and method to facilitate the rental of software for use on a user's computer.

### BACKGROUND OF THE INVENTION

Traditionally software for execution on a user's computer is provided to a user's computer either by downloading it or obtaining a copy on for example a CD-ROM. When software is loaded on a user's computer it allows the user complete flexibility regarding the use of the software. However, it requires the user to have a licensed version of the software on their computer. There are many disadvantages of this. It can be expensive for a user to have to purchase the software when they only require it for a limited period. There is also a problem for a user to continually update their software to the latest versions since this can not only be time consuming but also expensive.

An alternative model to providing software on a user's PC, is the application service provider (ASP) model whereby applications are hosted at a server and the user can access the software and use it on a subscription or rental basis without having to have the software loaded on their computer. This means that the ASP software can be kept up to date and a user can have access to a large number of applications for the period of use they require. The downside of this type of service is that a user must have access to a network in order to access the server.

It would be advantageous to overcome the limitations in the prior art and provide for the rental of software which provides for the full flexibility available when the software is loaded on a user's computer, whilst still maintaining the control offered by the ASP model.

### SUMMARY OF THE INVENTION

In accordance with the first aspect of the present invention a software rental system controlling the use of rented software on a computer comprises a control arrangement for storing access control parameters which are obtained and periodically updated from a server over a network according to user payment parameters at the server for each of a plurality of software programs. The control arrangement interacts with each of the software programs to control each of the software programs in accordance with respective access control parameters.

Thus in accordance with this aspect of the present invention each software program can be independently controlled in accordance with user payment parameters held at a server. This facilitates remote control of the capabilities of the software programs in accordance with user payment behaviour. The periodic updating of the access control parameters facilitates periodic updating of the control of the software programs. Thus, for example, when a user stops making regular rental payments, the access control parameters will indicate expiry of permission to use software. Different software programs can be controlled separately without requiring a user to access different vendors or rental outlets. In other words, the rental system offers access to an aggregation of software programs thereby simplifying aggregation of payment for the rental service.

In one embodiment the access control parameters can include an expiry date which is based on a most recent user payment for each of the computer programs. Control means are adapted to detect when a current date has passed any expiry date and generate a warning to the user. If the current date is within a grace period of the expiry date, the warning can simply be a warning that the user needs to renew their rental, e.g. make additional rental payments. When the current date has passed a grace period, the warning to a user can warn them that the software program has been deactivated and the software program can accordingly be deactivated. A user will then be required to access the server to make additional rental payments in order to have the software program reactivated.

In one embodiment of the present invention the software programs can be downloaded from the server in accordance with the user payment parameters. The present invention is not limited to the automatic downloading of the selected programs, since the programs could be provided to the user by the means e.g. by a separate transmission from a separate provider, or on a physical medium such as a CD-ROM. However, the automatic downloading of the software programs in accordance with the user payment parameters offers obvious advantages in that the provision and control of the software programs is brought together under the control of the server and the control means.

In one embodiment of the present invention, the system is able to automatically update versions of the software programs on the user's computer. The most up to date versions of the software programs are stored at the server and made available to the user's computer. Control means is adapted to detect the updated versions of the software programs at the server and to automatically download the updated versions. In this way, a user is offered a service akin to the ASP model, whereby the software that they operate is always the latest version. Thus the cost and labour involved in the user ensuring that they have the latest version of the software is removed.

In one embodiment a user interface is provided to allow a user to select to install the software programs downloaded by the control means onto the user's computer. In one embodiment this interface can be used to allow a user to select a software program that they wish to run and if the software program is already installed, it will run. If the software program is not installed then it will automatically install and thereafter execute. In this way the user interface can be used by the user as an interface for access to their applications.

In one embodiment the user interface can provide means e.g. a link by which a user can access the server in order to for example modify the user payment parameters by for example selecting further software programs that they wish to rent, or modifying payment information.

The control means of the present invention can be provided either by software or a combination of software and hardware. The control means can comprise a control module and interface code for interfacing to the software programs. Such a control module can comprise hardware or software. For example the hardware can comprise a device for attachment to the user's computer. One such known device is termed a “dongle”.

In one embodiment the interface code comprises interface codes specific to each software program. Thus in this embodiment each software program requires the rental service provider to provide interface code. The interface code is preferably independent of the software program such that the suppliers of the software program need not be involved in the provision of the rental services since their co-operation in the modification of their code is not required. An example of one type of interface code that can be used comprises code that executes in place of and before the software program.

In another embodiment of the present invention, the interface code comprises code for monitoring all of the software programs and for stopping or “killing” any of the software programs when the access control parameters indicate that a user does not have permission to use the software program. It is known in computer operating systems that the operation of programs can be monitored and controlled. The methodology of such a control depend upon the type of operating system. For example, in Microsoft Windows™ it is possible for code to operate as a system service that operates in the background and which can use standard operating system calls to monitor and “kill” software programs.

One embodiment of the present invention provides for the monitoring of the usage of the software programs and for storing usage data that is communicated to the server. At the server the usage data can then be stored and compared with the stored user data to compare the actual usage against the paid for rental service. This information can be used for rental service management e.g. to identify potential deviations from allowed use, and to enable the offering of modified rental services based on previous rental and usage behaviour.

A second aspect of the present invention provides a software rental system for allowing a user to rent software for use on a computer. Selection means allow for the selection of a plurality of software programs for rental from a library of stored software programs. A user can input payment information for the selected programs and this is stored as user payment parameters. A system communicates with a user's computer to transmit the selected software programs and the user payment parameters to the user's computer for control of the selected software programs.

In one embodiment a control program for controlling the selected software programs on a user's computer depends on the user payment parameters being stored and transmitted to the user's computer the first time the user inputs the user payment information i.e. the time they initiate use of the software for rental service. The control program can then automatically install itself on the user's computer to set up the complete software rental system.

In one embodiment updated versions of the control program are stored and can be transmitted to the user's computer so that the user computer can be constantly updated with the latest version of the control program.

The present invention can be implemented in software on a general purpose computer, or partly in software and partly in dedicated hardware. Software embodying the invention can be provided to a computer using any well known conventional carrier media such as, a transient medium, e.g. an optical signal, an electrical signal, a radio frequency signal, a magnetic signal, or an electromagnetic signal, or a carrier medium such as a hard disc, a floppy disc, CD-ROM, or solid state memory device.

In accordance with the present invention, the system can be implemented on any form of computing apparatus including personal computers, personal digital assistance (PDAs), mobile telephones (e.g. Smart phones) or any other digital processing device.

The present invention involves implementation over a communications network. Such a communications network can comprise any known communication network including the Internet, local area networks, wide area networks, WIFI networks, or any other wireless or wired networked system.

### BRIEF DESCRIPTION OF THE DRAWINGS

FIG. 1 is a schematic diagram of a user's computer in accordance with one embodiment of the present invention;

FIG. 2 is a schematic diagram of the content of the permissions file in accordance with an embodiment of the present invention;

FIG. 3 is a schematic diagram of the content of the download folder in accordance with an embodiment of the present invention;

FIG. 4 is a schematic diagram of the rental service server system in accordance with an embodiment of the present invention;

FIGS. 5a, 5b, 5c and 5d illustrate data tables stored in the database in the rental service server in accordance with an embodiment of the present invention;

FIG. 6 is a flow diagram illustrating the process for registration by a user to the rental service in accordance with an embodiment of the present invention;

FIG. 7 is a flow diagram illustrating the installation of the rental application and its operation in accordance with an embodiment of the present invention;

FIG. 8 is a flow diagram illustrating the operation at the rental service server to allow a user to select additional software programs for rent in accordance with an embodiment of the present invention;

FIG. 9 is a flow diagram illustrating the operating of the interface module on the user's computer in accordance with an embodiment of the present invention;

FIG. 10 is a flow diagram illustrating the operation of application interface code comprising stub code and DLL code in accordance with an embodiment of the present invention;

FIGS. 11a and 11b are flow diagrams illustrating operations at the rental service server in order to update user data and the permissions files based on user payment behaviour in accordance with an embodiment of the present invention;

FIG. 12 is a diagram illustrating an application interface code in accordance with a second embodiment of the present invention;

FIG. 13 is a diagram illustrating yet another application interface code in accordance with a third embodiment of the present invention;

FIG. 14 illustrates yet another application interface code in accordance with a fourth embodiment of the present invention; and

FIG. 15 illustrates a further application interface code in accordance with a fifth embodiment of the present invention.

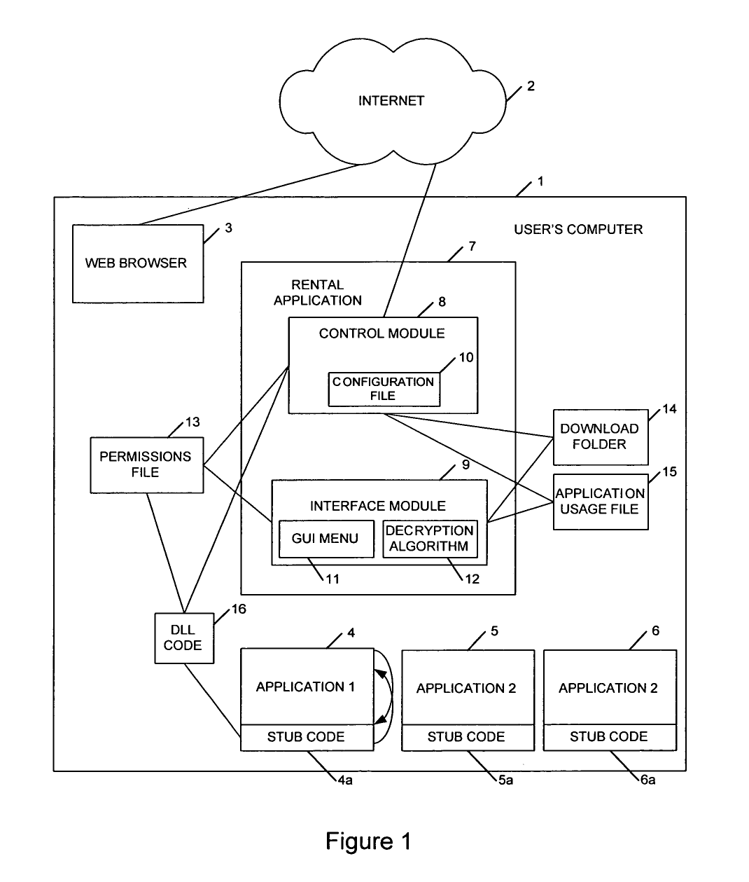

An embodiment of the present invention will now be described with reference to FIGS. 1 to 11.

### DETAILED DESCRIPTION OF EMBODIMENTS OF THE INVENTION

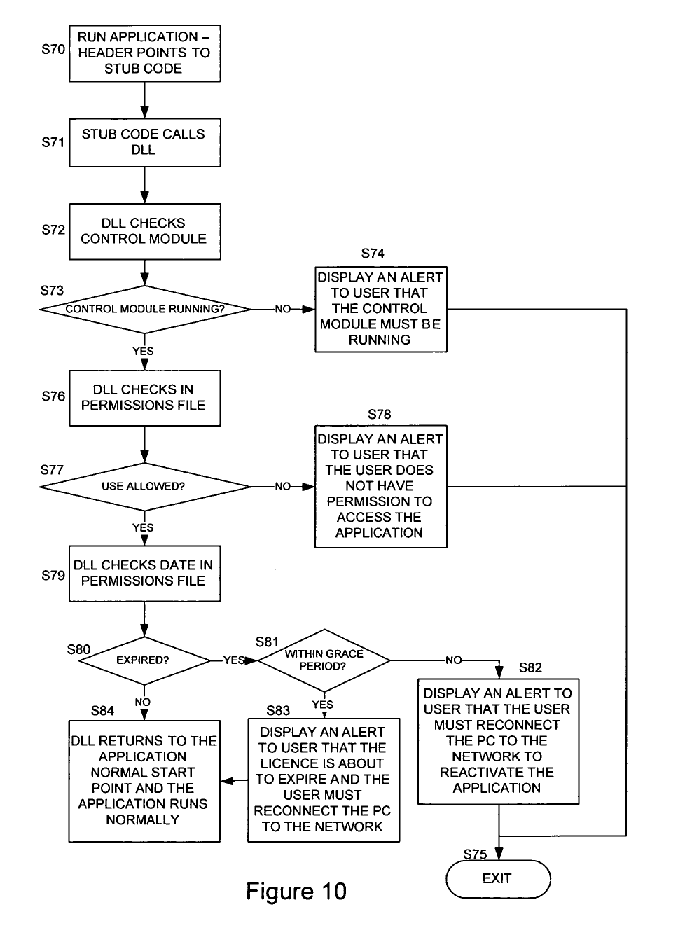

FIG. 1 is a schematic diagram illustrating a user's computer 1 connected to the Internet 2. The user's computer 1 is provided with a web browser 3 to enable a user to access the website of the rental service provider in order to subscribe to the rental service. The user's computer 1 is shown as having three applications 4, 5, 6 installed therein. These applications can comprise software programs for performing any conventional function. They can for example comprise a word processing application, a database application, an email client application, a photo-editing application, or a spreadsheet application. Each of the applications in this embodiment has an application interface code in the form of a stub code 4a, 5a, 6a associated therewith. In this embodiment the stub code is incorporated within the executable file (i.e. the file with the file extension .exe). The structure and operation of the stub code will be described in more detail with reference to FIG. 10.

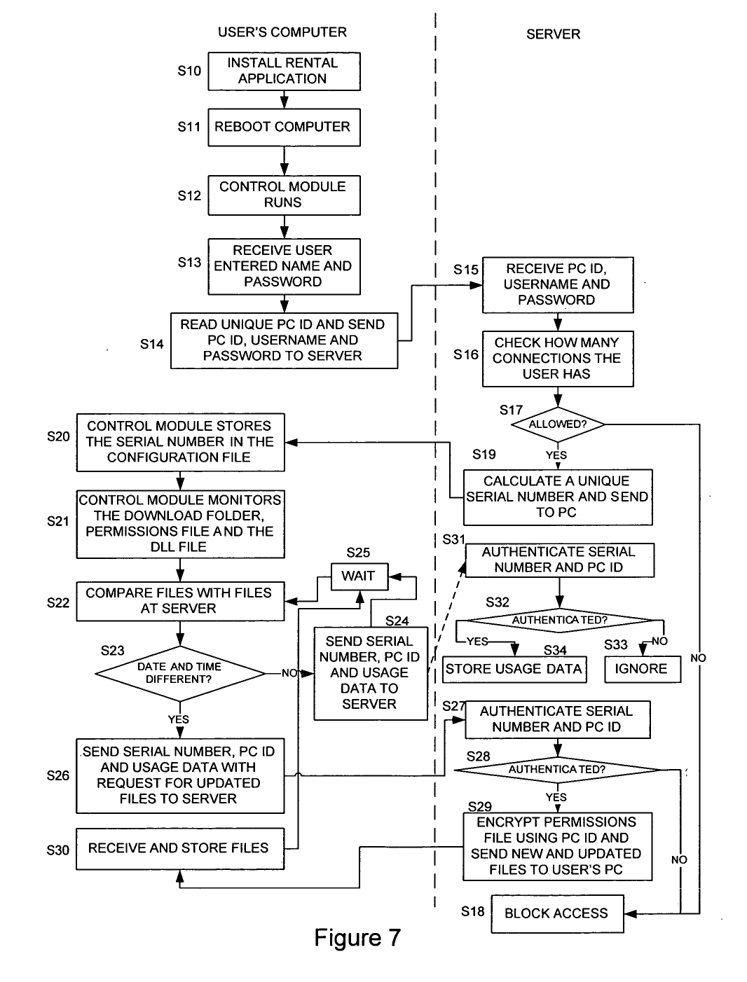

Installed on the user's computer 1 is a rental application 7 which comprises two components, a control module 8 and an interface module 9. The control module 8 is connected to the Internet 2 and it controls the communications to and from the rental service server as will be described in more detail hereinafter. The control module 8 includes a configuration file 10 that stores the unique serial number generated for the user's computer 1 by the rental service server. This will be described in more detail with reference to FIG. 7.

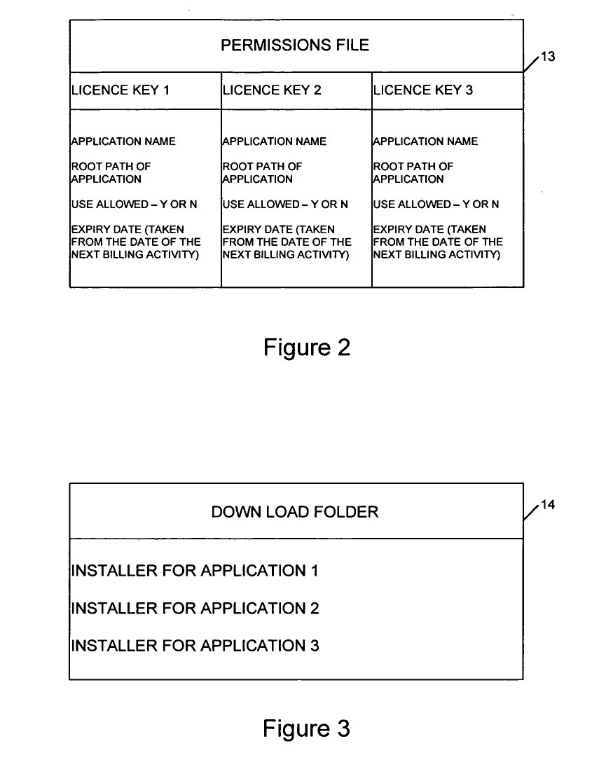

The interface module 9 includes a graphical user interface menu 11 to enable the user to interact with the rental application in order to access and install the downloaded applications 4, 5, 6. The interface module 9 also includes a decryption algorithm 12 required to decrypt information stored in the permissions file 13. The permissions file 13 is connected to the interface module 9 and the control module 8 and stores information to control access to the applications 4, 5, 6 as will be described in more detail hereinafter with reference to FIG. 2.

A download folder 14 is provided to store downloaded applications in the form of application installers for the installation of the applications on the user's computer 1. The download folder 14 is connected to the control module 8 so that the control module 8 can control the downloading of the applications as well as the interface module 9, since the interface module 9 allows a user access to select the available applications in the download folder via the GUI menu 11.

An application usage file 15 is provided on the user's computer 1 to store data on the usage made by the user of the applications 4, 5, 6. The application usage file 15 is connected to the interface module 9 and the control module 10 so that the interface module 9 can monitor the use of the applications 4, 5, 6 and the control module 8 can transmit the usage data over the Internet 2 to the rental service server.

DLL code 16 is provided and connected to the stub code 4a, the permissions file 13 and the control module 8. The DLL code 16 is provided to co-operate with the stub code 4a in order to control operation of the application 4.

FIG. 2 illustrates the content of the permissions file 13. As shown in FIG. 1 there are three applications 4, 5, 6 provided on the user's computer 1. Thus the permissions file 13 stores three encrypted license keys. Each license key contains the name of the application, the route path of the application i.e. the location of the application on the user's computer 1, whether or not use is allowed of the application, and an expiry date for the application. The expiry date is taken as the date in which the current payment period will expire i.e. the due date for the next billing activity.

FIG. 3 schematically illustrates the content of the download folder. The download folder contains install applications for installing each of the applications 4, 5, 6.

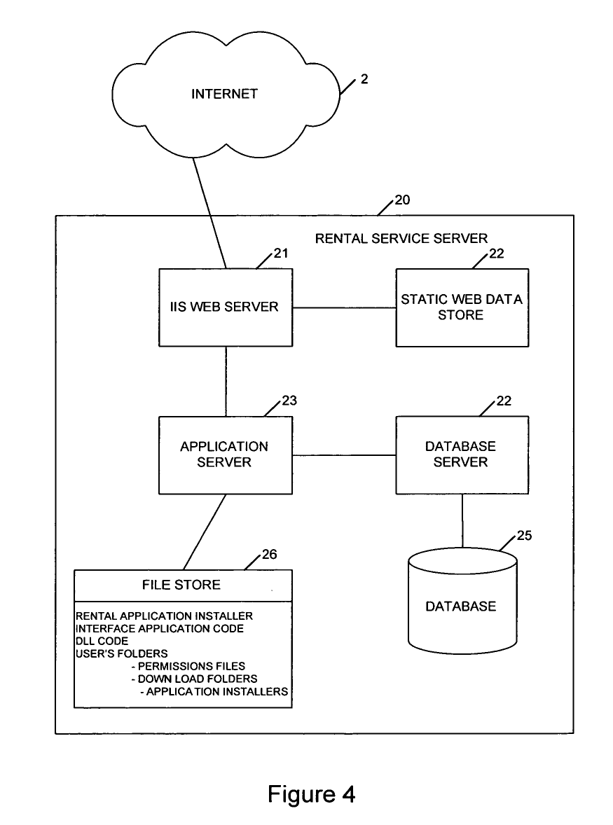

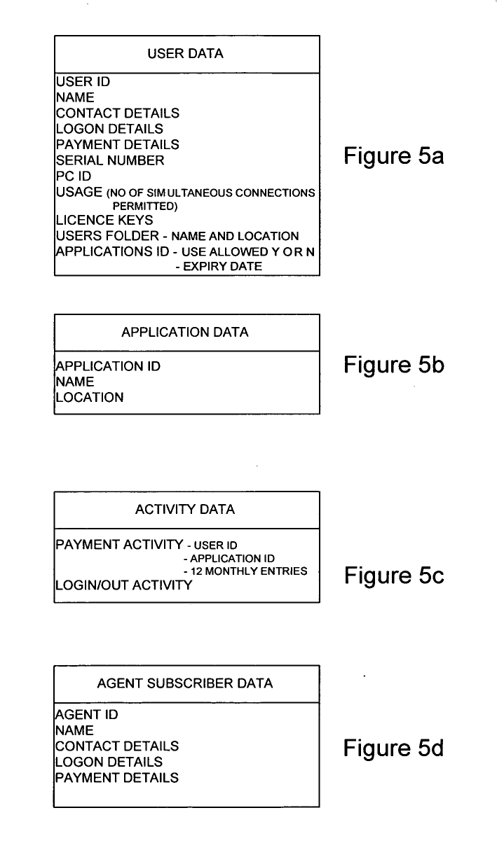

FIG. 4 is a schematic diagram of the rental service server 20 connected to the Internet 2. The rental service server 20 includes an IIS web server 21 connected to the Internet 2 to provide a web front end to enable a user to access the server website. The IIS web server 21 accesses a static web data store 22 to obtain static web pages. Connected to the IIS web server 21 is an application server 23 generating dynamic web pages to be served by the IIS web server 21, and for communicating with the user's computer 1 via the IIS web server 21. A database server 24 is connected to the application server 23 and a database 25. The content of the database 25 is described in more detail hereinafter with reference to FIGS. 5a, 5b, 5c, 5d.

A file store 26 is provided connected to the application server 23 in order to store the files and applications required by users. A file store 26 stores the rental application code as an installer so that the control module 8 and the interface module 9 can be installed separately if required so that when new versions of these are available they can be separately downloaded to the user's computer to update the way the user's computer interfaces to the rental service server 20. The file store 26 also includes the DLL code for download to the user's computer. The user's folders are provided in which are stored files that are specific to each user. The files comprise permissions files and download folders. The download folders contain the application installers to install the application required by the user.

The content of the database 25 will now be described with reference to FIGS. 5a, 5b, 5c, 5d.

The database 25 contains a set of data termed user data that comprises a unique user ID, a user name, the user's contact details, the user's log-on details, the user's payment details, a unique serial number for the user, a unique identification number for the user's computer, usage information indicating the number of simultaneous connections permitted for the user, license keys for software use by the user's computer, an identification for user's folder i.e. an indication of where the user's specific folder is in the file store 26, and an applications ID holding specific information on the applications indicating whether for each application a user is allowed to use the application and the particular expiry date for that application. The expiry date will be based upon the payment details.

FIG. 5b illustrates a set of data termed application data. This is data specific to each application and comprises a unique application ID, the name of the application and the location of the application on the server.

FIG. 5c illustrates activity data that comprises all forms of data stored indicating user activity. This includes payment activity that includes the unique user ID, an application ID, and 12 monthly entries indicating payment activity dates. Also stored is log-in and log-out activity data.

FIG. 5d illustrates the agents' subscriber data for agents operating on behalf of many users. The data comprises a unique agent ID, the name of the ID, contact details, the log-on details, and payment details.

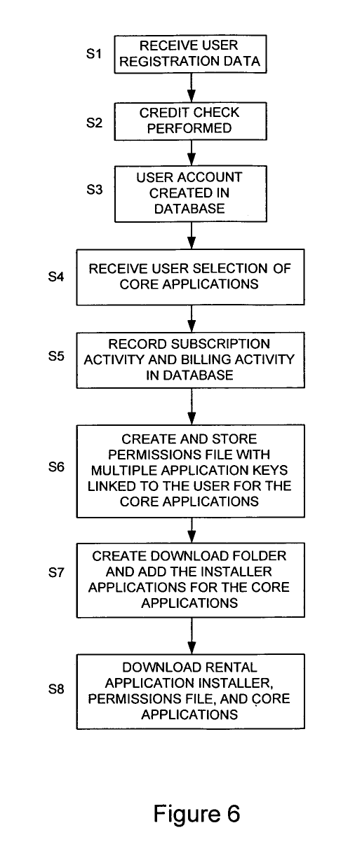

The operation of this embodiment of the present invention will now be described with reference to FIGS. 6 to 11.

FIG. 6 is a flow diagram illustrating the process whereby a user registers for the rental service and receives the applications and files necessary for utilisation of the service. In step S1 a user has accessed the website of the server and entered their registration data including their name, address, payment details and log-on data. In step S2 a credit check is performed to ensure that the user is credit worthy. A user account is then created in the database 25 (step S3) and a user can then proceed to make selections of the core applications that they wish to rent from the library of available applications (step S4). The application server 23 can then record subscription activity and billing activity in the database 25 (step S5) in order to record the fact that the user subscribed at a particular date and that billing payments are due at particular dates. These dates will form a basis for setting the expiry dates to be used to control the applications by the control module.

The application server 23 then creates and stores the permissions file for the user with multiple application keys linked to the user for the core applications as illustrated in FIG. 2 (step S6). The application server then creates the download folder in the file store 26 and adds the installer applications for the core applications (step S7). The application server 23 then proceeds to download the rental application installer, the permissions file and the core applications installed in the download folders to the user's computer over the Internet 2 (step S6).

FIG. 7 is a flow diagram illustrating the operation of the user's computer and the server in the installation and operation of the rental application 7 downloaded from the rental service server 20.

In step S10 the rental application installer code is run to install the rental application 7 on the user's computer 1. This installs the interface module 9, the control module 8, the download folder 14, and the permissions folder 13 and puts the core downloaded applications in the download folder 14 as installation files. It is then necessary for the user to reboot the user's computer (step S11) whereupon the control module 8 will automatically run in the background as an operating system service (step S12). The user must then enter their username and password on their computer 1 (step S13) and the control module reads a unique number from the hardware of the user's computer 1. This can comprise the serial number of any hardware components such as the hard disk, network cards etc. However, such components can be the subject of upgrades made to the hardware of the machine and thus the preferred serial number is the serial number of the motherboard since this is a component that is rarely upgraded or replaced. This unique PC ID is then send to the server together with the user's username and password (step S14). The server receives this (step S15) and checks to determine how many connections the user already has to the server (step S16). It is possible for a user to be allowed more than one connection to the server since a user could be a company with many users. This check is made against the data held in the database for the user and if it is determined that the number of connections allowed has been exceeded (step S17), access is blocked (step S18). If access is allowed (step S17), a unique serial number is calculated for the user's computer and this is sent to the user's computer 1 (step S19). The control module 8 in the user's computer 1 stores the unique serial number in the configuration file 10 (step S20).

The control module 8 is now operative and will periodically, e.g. every hour or every 24 hours, monitor the files (step S21) and compare them with the files at the server (step S22). The files comprise the files in the download folder 14, the permissions file 13, the DLL code file, and even the control module file and the interface module file so that updated code for these can be obtained and installed. If there is no difference in the date and time of creation of the files (step S23), the serial number, PC ID and usage data is transmitted to the server (step S24) and the monitoring process waits for the next monitoring period (step S25). At the server, the serial number and PC ID is authenticated (step S31) and if it is not authenticated (step S32), the uploaded usage data is ignored (step S33). If it is authenticated, the usage data is stored in the database for the user (step S34).

If the date and time of creation of any of the files is different i.e. the files are more recent on the server, the control module 8 sends the serial number, PC ID and the usage data to the server (step S26) with a request for updated files. The server authenticates the serial number and PC ID (step S27) and if they are not authenticated (step S28) access is blocked (step S18). If the serial number and PC ID are authenticated (step S28) the application server 23 encrypts the permissions file for security using the PC ID and sends the encrypted file together with the new and updated files to the user's computer 1 (step S29). These files are received and stored by the control module 8 in the user's computer (step S30). The process then returns to step S25 to wait until the next monitoring period occurs.

Thus, in this way the control module 8 keeps the files and applications on the user's computer 1 synchronised with those at the server 20 and thus in accordance with the rental requirements of the user.

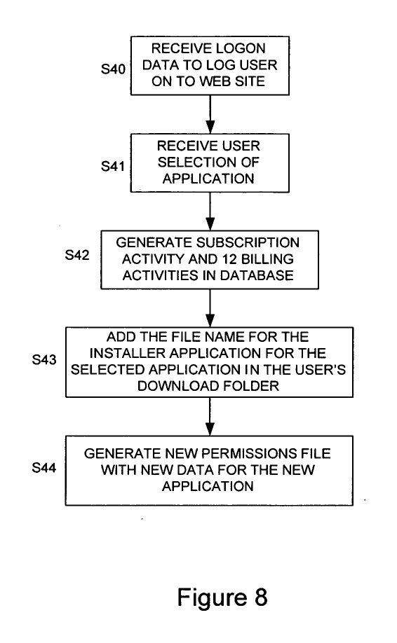

FIG. 8 is a flow diagram illustrating the process for a user to select to rent and download further applications. A user can log onto a web site hosted by the web server 21 where they can enter logon data to access the rental service (step S40). A user can then select new applications for rental from a displayed library of applications (step S41). The selection of the applications can automatically generate billing requirements. These can be confirmed as accepted by the user and then the application server 23 generates subscription activity indicative of the users activities in subscribing to the rental service, and billing activities that comprise 12 monthly billing activities indicative of payment points at which a user's monthly payment is due (step S42). The application server 23 adds the file name for the installer applications for the selected applications to the user's download folder on the server 20 (step S43) so that at the next synchronisation by the control module 8, the applications will be downloaded. Also, a new permissions file for the user is generated with the new data for the application as illustrated in FIG. 2 (step S44).

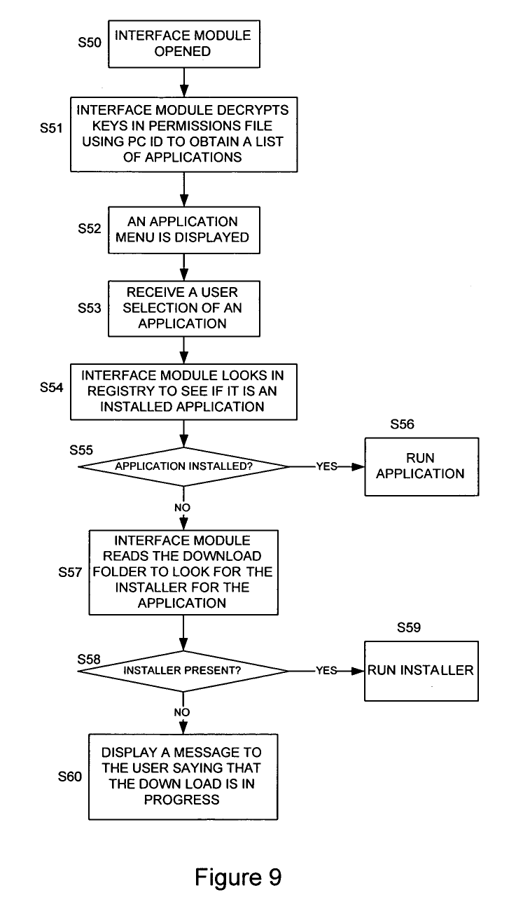

FIG. 9 is a flow diagram illustrating the operation of the interface module 8. The interface module 8 is an application that can appear as an icon on a user's desktop for example in Microsoft Windows™. Thus a user can select to open the interface module 9 (step S50) whereupon the interface module 8 uses the decryption algorithm 12 to decrypt the keys in the permissions file 13 using the PC ID to obtain a list of the applications available to the user under the rental service (step S51). A menu listing the available applications is displayed (step S52). A user can select to run an application from this menu (step S53), whereupon the interface module 8 looks at the operating system registry to determine if the application is installed (step S54). In the Microsoft Operating System™ the registry keeps track of all installed applications and thus the interface module 9 can use this to identify which applications have been installed. If an application has been installed (step S55) the user selection of the application simply enables the application to be executed (step S56). If it is determined that the application is not installed (step S55), the interface module 8 looks in the download folder 14 to determine whether the installer file for the application is present (step S57). If the installer application is present (step S58) then the installer application is run to install the application on the user's computer 1 (step S59). If the installer application is not present in the download folder (step S58), the interface module displays a message to the user saying that the download is still in progress (step S60). In this instance, the user has paid for and has permission to access the application, but since the installer application is not yet available in the download folder, the control module and the server have not yet completed synchronisation of the files and hence the installer application download has not yet been completed.

Thus the interface module 9 acts as a simple user interface to allow user access to the applications for which they have subscribed. The user interface 9 can be used as a means by which to install rented applications, and a means by which such applications can be executed. Since the applications are installed on the user's computer 1 in the usual manner with a minor modification in order to monitor and control the activation of the applications, as will be described in more detail hereinafter, a user can additionally execute the applications by the usual means e.g. by selection of an icon on Microsoft Windows™ desktop. Thus the interface module is not an essential feature of the invention since it is possible for the applications to be installed by other means. For example, when the user comprises a single user in a company, the IT department of that company may well perform the installation process on behalf of the user and thus the interface module is not required.

The interface module 9 in this embodiment can also perform the function of monitoring usage of the applications. Part of the information downloaded from the server as configuration data for each application is details of what the application process is called when it is running. The method by which usage of the applications can be monitored involves standard operating system functions to track operation of the applications by regularly e.g. every 30-60 seconds) polling the operating system's running process list. A log file can be created containing the start and stop notifications and this is stored in the application usage file 15 for upload to the server.

The operation of the stub code 4a and the DLL code 16 will now be described in more detail.

In the present invention custom code (stub code) can be injected into executable files such as Win 32 portable executable (PE) files (.exe files). The process of injection involves the creation of a new section within the PE file. The customer assembly code is injected into this new section and the PE data about pointers and size flags are changed. The entry point of the executable is modified to start at the newly injected code in the new PE section (stub code 4a). The original entry point of the program is stored and the stub code will jump back to the original entry point if successful execution of the DLL code 16 is completed. The file size of the executable is thus increased slightly.

For a more detailed operation the stub code and the DLL code will now be described with reference to FIG. 10.

When the modified application including the stub code 4a is run the header points to the stub code (step S70) which then loads the DLL into memory. The DLL file comprises a dynamic link library file written in assembler that executes functions within it. DLL files are commonly used by applications, as is well known in the art.

The DLL checks that the control module 8 is currently running (step S72). If the control module 8 is not currently running (step S73) an alert is displayed to the user that the control module must be running in order to access the rented application (step S74). The execution of the application 4 will then immediately exit (step S75).

If the control module 8 is detected as running (step S53) the DLL locates and reads the permissions file 13 which contains information regarding the usage of the application allowed by the user's computer as illustrated in FIG. 2 (step S76). The permissions file 13 indicates whether usage of the application is allowed or disallowed. If usage is not allowed (step S77) an alert is displayed to the user stating that the user does not have permission to access the application (step S78) and the application immediately terminates (step S75).

If the permissions file 13 indicates that usage of the application is allowed (step S77), the DLL then checks the expiry date in the permissions file 13 to determine whether usage of the application has expired (step S79). If the expiry date has not passed (step S80) the DLL 16 exits thereby returning control back to the stub code 4a. The stub code then passes control back to the original entry point of the application allowing the application 4 to function as normal (step S84).

If the expiry date has passed (step S80) it is then determined whether the current date is within a grace period e.g. seven days (step S81). If the current date is within the grace period (step S81) an alert is displayed to the user that their license for the software is about to expire and the user must reconnect their computer to the network in order to update their permissions (step S83). The process then returns to step S84 whereby the DLL exits. The purpose of the alert displayed to the user is to allow the user to work offline although their permissions file may become out of date. The user need only connect in order to update their permissions file and update the expiry date when the alert notification is displayed. Thus for example if a user makes 12 monthly payments, the activity date will contain 12 payment points and hence there are 12 potential expiry dates dependent upon whether payment is made or not. Thus, if a user uses a computer offline over a period where payment is made and thus a new expiry date is entered into the permissions file, when the out of date expiry date on the user's computer is passed, a user will be warned to reconnect to the network to resynchronise their permissions file. Of course, if the user has not made a payment, there will be no resynchronisation of the permissions file. It is of course up to the user to ensure that payments for rental of their applications is made.

If the current date is outside the grace period (step S81) an alert is displayed to the user to inform the user that they must reconnect their computer to the network in order to reactivate the application (step S82) and execution of the DLL is terminated without passing control back to the stub code. Thus execution of the application is prevented (step S75).

In this embodiment of the present invention, when the applications 4, 5, 6 are installed on the user's computer 1 by the interface module 9, when the vendor's original setup program has completed, a setup wrapper then runs to replace the vendor's original executed file with the modified application file containing the stub code. This the applications installed in the download folder contains the vendor's application plus a setup wrapper for the replacement of the original executable with the modified executable.

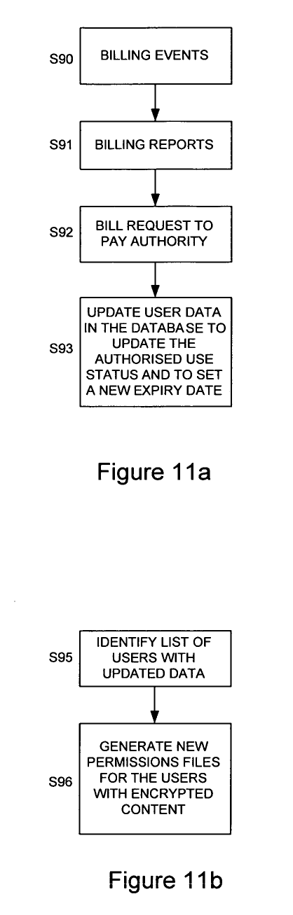

The operation of the rental service server 20 in the updating of the data and permissions file in accordance with billing activity will now be described with reference to FIGS. 11a and 11b.

When billing events are triggered i.e. at payment due dates indicated in the activity data illustrated in FIG. 5c (step S90) the server will generate billing reports (step S91). When authorised payments are received (step S92) user data in the database is updated to update the authorised use status and to set new expiry dates in the user data illustrated in FIG. 5a (step S93). Thus, in this way the data in the database 25 is updated periodically in accordance with billing events.

FIG. 11b illustrates the process for updating the permissions files at the server. A list of users with updated data is identified (step S95) and the new permissions files are generated for the identified users with content encrypted using the PC ID for the user (step S96).

Although the embodiment described hereinabove with reference to FIGS. 1 to 11 has been described with reference to execution in a Windows™ operating system environment, the present invention is not limited to any particular operating system environment.

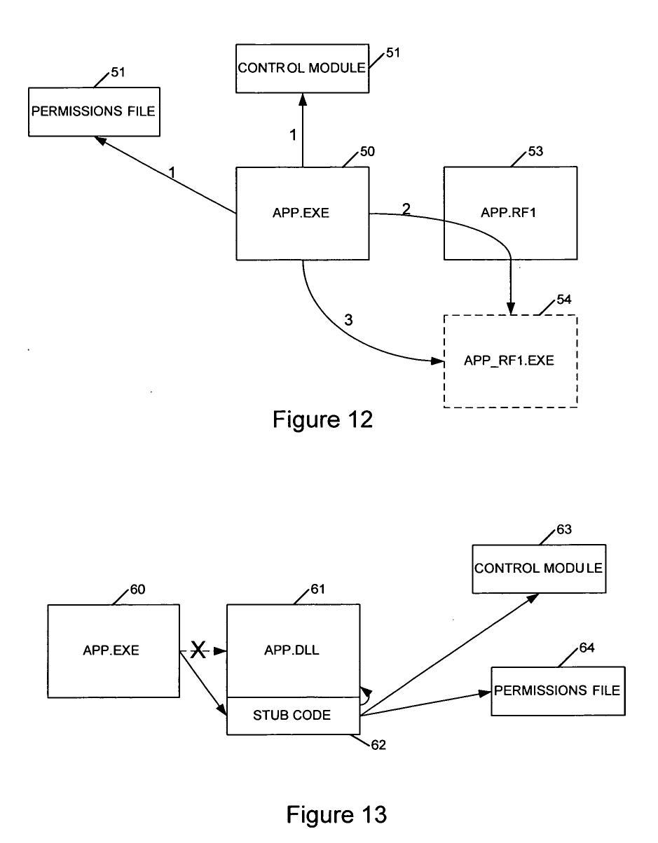

A second embodiment of the present invention will now be described with reference to FIG. 12.

In this embodiment the stub code and DLL code of the first embodiment of the present invention is replaced. The permissions file 51 and the control module 61 are similar to the first embodiment. In this embodiment the executable application 50 comprises a new application. The original application app.exe is renamed during installation as app.rfl. In this way the original executable code is disguised so that the average user is unlikely to be able to identify it and run it without permission. Thus the file app.exe 50 illustrated in FIG. 12 is a new code component written to control access to the original application. Thus when a user requests to execute the application app.exe 50, they are in fact executing a control code which will, in a similar manner to the first embodiment, check to determine as a first step whether the control module 61 is present and whether the permissions file 51 indicates that the expiry date has not passed and that the user has permission to use the application. If the application app.exe 50 determines that the control module is present and the permissions file 51 allows execution of the original application, the application app.exe 50 will then rename the application app.rfl 63 as app_rfl.exe 54 and will then pass control to the application app_rfl.exe 54 thereby allowing the original application to run as normal.

FIG. 13 illustrates a third embodiment of the present invention.

In this embodiment of the present invention, the stub code and the DLL code of the first embodiment of the present invention is replaced with stub code 62 injected into a DLL file 61 referenced by the application 60. In this embodiment of the present invention, the control module 63 and the permissions file 64 are the same as that described with reference to the first embodiment. The only difference between the first embodiment and this embodiment is the replacement of the DLL code 16 and stub code 4a with the stub code 62. Also the application app.exe 60 includes an external DLL 61 required for execution of the application.

In this embodiment when the stub code 62 is injected into the DLL code 61, the address mappings in the DLL are rewritten so that specific application calls are redirected through the stub code 62. Thus when the application 60 calls the DLL, the calls are routed to the stub code 62 rather than the DLL 61. The stub code 62 then performs the check on the control module 63 and the content of the permissions file 64 as previously described with reference to the first embodiment. If execution of the application is permitted, the stub code 62 passes the call back into the existing DLL 61 for normal execution of the application.

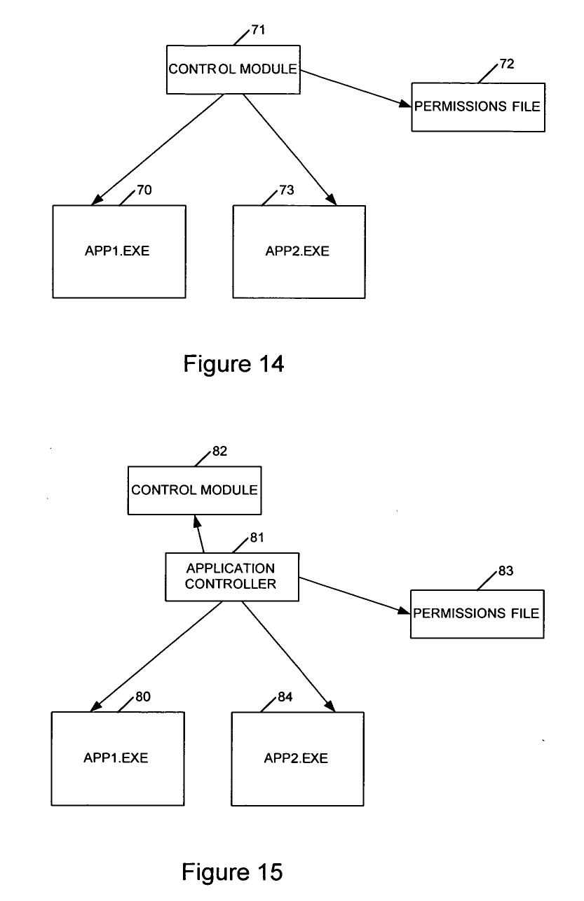

The fourth embodiment of the present invention will now be described with reference to FIG. 14.

In this embodiment, the control module 71 performs all the control and access functions performed by a control module 8 and a DLL code 16 and the stub code 4a of the first embodiment of the present invention. The control module 71 checks the permissions file 72 to determine whether a user is authorised to access applications and whether use has expired. As previously described with reference to the first embodiment, the control module 71 comprises an executable file which can be hidden on the user's computer by giving it a spurious name such as PrtDrv.exe so as to hide its true purpose. The control module is created as a system service in the Microsoft Windows™ operating system. Such a service operates in the background in the operating system.

Control module 71 monitors the list of currently running applications, which is available via the operating system, and checks the permissions file 72 to determine if use is authorised. If the control module 71 detects that an authorised application is operating, it kills it using standard operating system calls.

Thus in accordance with this embodiment of the present invention, all the functionality of the control module is included in a single system service.

FIG. 15 illustrates a fifth embodiment to the present invention similar to the fourth embodiment of the present invention.

In this embodiment of the present invention, rather than there being a single system service providing all of the functionality as described in the fourth embodiment of the present invention, the control module 82 operates as a system service performing the functions as described with reference to the first embodiment to the present invention. An application controller 81 comprises a system service performing the functions of the DLL code 16 and stub code 4a of the first embodiment of the present invention. In other words, the application controller 81 runs in the background and will monitor the list of currently running applications 80 to 84. It will check to determine that the control module 82 is present and that the application is a permitted application in accordance with the date stored in the permissions file 83. If the application controller 81 detects an unauthorised application it kills it using standard operating system calls. Additionally if it detects that the control module 82 is not running, it can kill any applications that are running which are identified as rental applications. In order to do this, the application controller 81 can be provided with a list of rental applications.

Although the present invention has been described with reference to specific embodiments, it will be apparent to a skilled person in the art that modifications lie with the spirit and scope of the present invention.

For example, although control of access in all of the embodiments has been described with reference to a permissions file, data parameters indicative of allowed use of applications can be stored as part of controlling code, or in any data location.

Downloaded applications are described in the embodiments as being stored in a download folder. However, the present invention is not limited to the downloading of the software and a separate method can be provided in alternative embodiments for the installation of software which can be obtained by other means.

What is claimed is:

1. A software rental system for controlling the use of rented software on a computer, the system comprising:
control means for storing access control parameters, said control means being adapted to obtain and periodically update said access control parameters from a server over a network according to user payment parameters at said server, for each of a plurality of software programs;
wherein said control means is adapted to interact with each said software program to control each said software program in accordance with respective said access control parameters.

2. A software rental system according to claim 1, wherein said access control parameters include an expiry date based on a most recent user payment for each said computer program, and said control means is adapted to detect when a current date has passed any said expiry date but not a grace period and generate a warning to said user.

3. A software rental system according to claim 2, wherein said control means is adapted to, when the current date has passed any said expiry date and exceeded said grace period, deactivate any of said software program for which the expiry date and grace period has passed, and generate a warning to said user to reactivate said any software program.

4. A software rental system according to claim 1, wherein said control means is adapted to download said software programs from said server in accordance with said user payment parameters.

5. A software rental system according to claim 4, wherein said control means is adapted to detect updated versions of said software programs at said server and to automatically download said updated versions.

6. A software rental system according to claim 4, including a user interface adapted to allow a user to select to install said software programs downloaded by said control means.

7. A software rental system according to claim 6, wherein said user interface is adapted to allow a user to select any said software program for which rental payments have been made according to said access control parameters, to detect whether a selected software program is installed on said computer, and to run said selected software program if it is installed, or install said software program if it is not installed.

8. A software rental system according to claim 6, wherein said user interface is adapted to allow a user to access said server to modify said user payment parameters.

9. A software rental system according to claim 6, wherein said user interface is adapted to allow a user to access said server to request additional software programs to be downloaded to said computer.

10. A software rental system according to claim 1, wherein said control means comprises a control module and interface code for interfacing to said software programs.

11. A software rental system according to claim 10, wherein said control module comprises control hardware.

12. A software rental system according to claim 10, wherein said control module comprises control software.

13. A software rental system according to claim 10, wherein said interface code comprises interface code specific to each said software program.

14. A software rental system according to claim 13, wherein said interface code comprises code for execution in place of and before each said software program.

15. A software rental system according to claim 10, wherein interface code comprises code for monitoring all said software applications and for killing any said software program when said access control parameters indicate that a user does not have permission to use said software program.

16. A software rental system according to claim 1, including monitoring means for monitoring usage of said software programs and for storing usage data, wherein said control means is adapted to communicate said usage data to said server.

17. A software rental method for controlling the use of rented software on a computer, the method comprising:
obtain and periodically update access control parameters from a server over a network according to user payment parameters at said server, for each of a plurality of software programs; and
interacting with each said software program to control each said software program in accordance with respective said access control parameters.

18. A software rental method according to claim 17, wherein said access control parameters include an expiry date based on a most recent user payment for each said computer program, detecting when a current date has passed any said expiry date but not a grace period, and generating a warning to said user.

19. A software rental method according to claim 18, wherein, when the current date has passed any said expiry date and exceeded said grace period, any of said software program for which the expiry date and grace period has passed are deactivated, and a warning is generated to said user to reactivate said any software program.

20. A software rental method according to claim 17, including download said software programs from said server in accordance with said user payment parameters.

21. A software rental method according to claim 20, including detecting updated versions of said software programs at said server and automatically downloading said updated versions.

22. A software rental method according to claim 20, including receiving a user selection to install said software programs downloaded by said control means.

23. A software rental method according to claim 22, including receiving a user selection of any said software program for which rental payments have been made according to said access control parameters, detecting whether a selected software program is installed on said computer, and running said selected software program if it is installed, or installing said software program if it is not installed.

24. A software rental method according to claim 22, including receiving a user request to access said server to modify said user payment parameters, and transmitting said request to said server.

25. A software rental method according to claim 22, including receiving a user request to access said server to request additional software programs to be downloaded to said computer, and transmitting said request to said server.

26. A software rental method according to claim 17, including monitoring usage of said software programs, storing usage data, and communicating said usage data to said server.

27. A carrier medium carrying computer readable code for controlling a computer to carry out the method of claim 17.

28. A software rental system for allowing a user to rent software for use on a computer, the system comprising:
selection means for selecting a plurality of software programs for rental from a library of software programs;
software storage means for storing said software programs;
input means for inputting user payment information for said selected software programs;
parameter storage means for storing said user payment information as user payment parameters;
communication means for communicating with a user's computer to transmit said selected software programs and said user payment parameters to said user's computer for the control of said selected software programs.

29. A software rental system according to claim 27, including control program storage means for storing a control program for controlling said selected software programs on said user's computer in dependence upon said user payment parameters, wherein said communication means is adapted to transmit said control program to said user's computer a first time the user inputs user payment information.

30. A software rental system according to claim 28, wherein said control program storage means is adapted to store an updated version of said control program and said communication means is adapted to transmit said updated version of said control program to said user's computer.

31. A software rental system according to claim 27, including payment update means for updating said user payment parameters based on user payment history, and said communication means is adapted to communicate said user payment parameters to said user's computer in response to periodic requests from said user's computer.

32. A software rental method for allowing a user to rent software for use on a computer, the method comprising:
receiving a user selection of a plurality software programs for rental from a library of software programs;
receiving a user input user payment information for said selected software programs;
storing said user payment information as user payment parameters;
communicating with a user's computer to transmit said selected software programs and said user payment parameters to said user's computer for the control of said selected software applications.

33. A software rental method according to claim 32, including storing a control program for controlling said selected software programs on said user's computer in dependence upon said user payment parameters, and transmitting said control program to said user's computer a first time the user inputs user payment information.

34. A software rental method according to claim 33, including storing an updated version of said control program and to transmitting said updated version of said control program to said user's computer.

35. A software rental method according to claim 32, including updating said user payment parameters based on user payment history, and communicating said user payment parameters to said user's computer in response to periodic requests from said user's computer.

36. A carrier medium carrying computer readable code for controlling a computer to carry out the method of claim 32.

37. A method of renting software comprising:
receiving a rental request;
providing software to a user;
receiving regular payments for the rented software; and
if payment is not received at any regular point in time, deactivating said provided software.

38. A method according to 37, including automatically providing updated version of said software to said user while regular payments are received.

39. A method of renting software comprising:
receiving a rental request;
providing software to a user;
monitoring use of said software;
comparing use of said software with said rental request; and
if the monitored use exceeds said rental request, deactivating said software.

40. A method according to claim 39, including informing the user that their rental request has been exceeded before said deactivation step, and if an additional rental payment is received, updating said rental request, re-comparing use of said software with said updated rental request, and only deactivating said software if the monitored use exceeds said updated rental request.
